(19) United States
(12) Patent Application Publication
(10) Pub. No.: US 2010/0235529 A1
(43) Pub. Date: Sep. 16, 2010

(54) Contents providing apparatus, contents providing method, playback program for stream contents, and recording medium on which playback program for stream contents is recorded

(75) Inventor: Koichiro Watanabe, Saitama (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/591,907

(22) Filed: Dec. 4, 2009

Related U.S. Application Data
(63) Continuation of application No. 10/398,579, filed on Sep. 29, 2003, now abandoned.

(30) Foreign Application Priority Data
Aug. 15, 2001 (JP) 2001-246349

(51) Int. Cl. G06F 15/16

(52) U.S. Cl. 709/231

(57) ABSTRACT

In situations where content such as music and movies are distributed through the interne, systems, methods and apparatus that provide time information to a transmission target of stream contents, watch the playback condition of a part specified by at least this time information, and make it possible to carry out the playback of the following stream contents.

### CROSS REFERENCE TO RELATED APPLICATION

This is a Continuation Application of U.S. patent application Ser. No. 10/398,579, filed Apr. 8, 2003, which is based on a National Stage Application of PCT/JP02/07588, filed Jul. 26, 2002, which in turn claims priority from Japanese Application No. 2001-246349, filed Aug. 15, 2001, the entire contents of which are incorporated herein by reference.

### BACKGROUND OF THE INVENTION

1. Technical Field

The present invention relates to contents providing apparatus, contents providing method, a playback program for stream contents, and a recording medium on which a playback program for stream contents is recorded, and it is able to apply to the case where music and video are distributed through the Internet, for example. The present invention notifies a transmission target of time information of the stream contents, watches a playback condition of a part specified at least by the time information, and only in the case when the operation at a reception side is done as intended by a distribution side, the playback for the following stream contents is set to be available, and accordingly, it is able to reflect the intention of the distribution side to an operation of the reception side.

2. Background Art

Conventionally, in a distribution of information such as music, movie, and the like where contents change by a lapse of time (it is referred to as stream contents here-in-after), one stream content including a plurality of continuing stream contents is presented by sequentially presenting the plurality of stream contents as necessary.

FIG. 1 is a block diagram showing a distribution system related to such distribution method. In this distribution system 1, a client terminal 2 is a computer connected to a network, such as the Internet or the like, and is a receiving apparatus for the contents. A service server 3 functions as an Http server, and executes introductions or the like of the contents that are available for provision by accessing from the client terminal 2. The contents server 4 provides the contents by accessing from the similar client terminal 2.

In distribution system 1, as shown in FIG. 2, by accessing the service server 3 from the client terminal 2, the processing proceeds a step SP1 to a step SP2, and a request for a web page from the client terminal 2 is accepted by the service server 3. Based on this request, in a following step SP3, the service sever 3 transmits web page contents introducing the stream contents available for provision, and the client terminal 2 displays the web page contents by a browser.

Further, in this distribution system 1, in a step SP4, user-desired stream contents are selected by selection of a user in this web page content, and in a succeeding step SP5, the corresponding URL of the contents server 4 is notified from the service server 3 by the selection of this user.

Further, in a succeeding step SP6, the request by this URL is notified from the client terminal 2 to the contents server 4, and in a succeeding step SP7, provision of the contents is started from the contents server 4. Further, in a succeeding step SP8, a playback of the stream contents is started, the processing proceeds to step SP9, and the processing procedure ends. Thereby, in the distribution system 1 , the user-desired stream contents are set to be provided,

On the contrary, as shown in FIG. 3, in a distribution of stream contents, there is also a case where one stream content (FIG. 3B) is divided by a time sequence into plural stream contents (FIG. 3A), and one content is distributed by sequentially distributing thus-obtained plural contents A, B, and C.

In this case, in the service server 3, the URL 5 of each content A, B, and C are recorded to form an URL table as shown in FIG. 4, and by retrieving the URL table and providing the corresponding URL to the client terminal 2, these continuing contents A, B, and C are set to be sequentially provided to a user.

In other words, as shown in FIG. 5, in this case, in the distribution system 1, by the access of the service server 3 from the client terminal 2, the processing proceeds from a step SP11 to a step SP12, and the request for the web page from the client terminal 2 is accepted by the service server 3. By this request, in a continuing step SP13, the service server 3 issues web page contents introducing the contents that are available for provision, and in the client terminal 2, these web page contents are displayed by a browser.

Subsequently, in this distribution system 1, in a step SP14, user-desired contents are selected in this web page contents by the selection of a user, and in a continuing step SP15, the corresponding URL of the contents server 4 is notified from the service server 3 of this selection of a user. In this case, the service server 3 notifies the URL of the contents corresponding to the access in accordance with the record of the URL among URLs of continuing plural contents. In addition, by the repetition of accessing, the signal indicating the end is issued for the access after notifying the URL of the last content.

Thereby, in a continuing step SP16, the client terminal 2 determines whether the signal of the end from the service server 3 is acquired or not, and when a negative result is acquired, the processing proceeds to a step SP17. Here, the client terminal 2 requests the insurance of stream contents by accessing the contents server 4 with the URL obtained from the service server 3 and receives the stream contents transmitted from the contents server 4 in a step SP18 followed by this request. Further, in a continuing step SP19, it carries out a playback of thus-received stream contents, and when the playback is completed, the processing returns to the step SP15.

Thereby, in this distribution system 1, the processing procedure of the steps SP15-SP16-SP17-SP18-SP19-SP15 is repeated at every consecutive stream contents A, B, and C, and when the playback of all the stream contents is finished, then an affirmative result is acquired in the continuing step SP16 by issuing the signal of the end in the step SP15, the processing proceeds to a step SP20, and this processing procedure ends.

Thereby, in the client terminal 2 as shown in FIG. 6, the stream contents divided into plural contents are to continuously carry out the playback by repeating a request for the URL to the service server 3 and a contents request by the URL obtained as the result to the contents server 4.

Resultantly, the distribution of the stream contents shown in FIG. 5 and FIG. 6 is the case where, in the reception side, the stream contents are distributed by the stream distribution which provides the stream contents to a user by decoding while receiving. In the distribution of the stream contents, opposite to this, there is the case where, in the reception side, the stream contents are distributed by the buffering distribution which distributes all the data of the contents to a user after buffering. FIG. 7 is a flow chart showing the processing procedure by this buffering distribution.

In other words, in the distribution system by the buffering distribution, by the access of the service server 3 from a similar client terminal 2, the processing proceeds from a step SP21 to a step SP22, and a request for the web page from the client terminal 2 is accepted by the service server 3. Further, by this request, in a continuing step SP23, the service server 3 issues web page contents for introducing the contents that are available for provision, and in the client terminal 2, these web page contents are displayed by the browser.

Further, in this distribution system 1, in a step SP24, user-desired contents are selected in accordance with the selection in the web page contents by the user, and in a continuing step SP25, the URL table in the contents server 4 is notified from the service server 3 of the selection by the user.

In the distribution system, in a continuing step SP26, the distribution of the stream contents are requested from the client terminal 2 with this URL table to the contents server 4, and in a continuing step SP27, all of the stream contents constructing one content are downloaded into the client terminal 2.

Furthermore, in a continuing step SP28, an authorization for playback of the stream contents is requested of the service server 3, and in a continuing step SP29, it is determined whether the request is authorized or not. When an affirmative result is obtained, the processing proceeds to a step SP30, and the playback for the stream contents is started at the client terminal 2, and when the playback of one stream content is completed, then in a step SP31, it is determined whether the playback of one content is completed or not. When a negative result is obtained here, the processing proceeds from a step SP31 back to the step SP28, and an authorization for playback with regard to following stream contents is requested of the service server 3.

Thereby, in this case, after all of the stream contents have once carried out the buffering by downloading, with the authorization of the service server 3, continuing stream contents are carried out by playback, and when the playback of all of the stream contents is completed, then the processing proceeds from the step SP31 to a step SP32, and the processing procedure ends. In addition, when the playback is not authorized in any stream content by an untreated charging and the like, the processing proceeds from the step SP29 to the step SP32, and the playback of the stream contents is stopped.

Thereby, in the case of such buffering distribution, as shown in FIG. 8, all of the stream contents are sequentially carried out by playback with the authorization of the service server 3 after buffering once.

By the way, in the distribution of the stream contents of this kind, it is thought that extremely important information is distributed by burying it in one part of the stream contents, and an attempt is made to keep every one informed on such important information. However, conventionally, in the distribution system, playback is entrusted to the operation of a user, so that it is thought that the part to which the important information is buried is carried out by a fast-forward playback in spite of the intention of such transmission side.

If it is able to reflect the intention of the distribution side to the operation of the reception side, it is thought that the usability of the system of this kind can be improved more remarkably.

### DISCLOSURE OF THE INVENTION

The present invention is made in consideration of the above-mentioned point to propose a contents providing apparatus that is able to reflect an intention of a distribution side to an operation of a reception side, a contents providing method, a playback program for the stream contents, and a recording medium on which a playback program for stream contents is recorded.

In order to solve the above-mentioned problems, the present invention is applied to a contents providing apparatus which makes the apparatus available to provide the stream contents to a client terminal depending on a request from the client terminal, and it notifies the client terminal of time information of a part to which important information is assigned in the stream contents.

According to the construction of the present invention, by applying to a contents providing apparatus that is able to provide stream contents to the client terminal depending on a request from the client terminal, and by providing the time information to which the important information is assigned in the stream contents to the client terminal, it is able to execute processing such as making it difficult to playback the following contents and the like without carrying out the playback with a normal playback speed by the time information in the client terminal side, and thereby the intention of the distribution side is able to be reflected to the operation of the reception side.

In addition, the present invention is applied to a contents providing apparatus for receiving the stream contents transmitted from a predetermined server and providing the same to a user by carrying out the playback of this stream contents, watches the playback condition of the predetermined part specified by the time information transmitted from the server, at least, and stops the playback of following stream contents based on the playback condition.

According to the construction of the present invention, it is applied to a contents providing apparatus for receiving the stream contents transmitted from the predetermined server and providing the same to a user by carrying out the playback of this stream contents, watches the playback condition of the predetermined part specified by the time information provided by the server, at least, and stops the playback of following stream contents based on the playback condition, therefore, if this part does not carry out the playback with a normal playback speed, it is able to make difficult the playback of following stream contents, and thereby, it is able to reflect the intention of distribution side to the operation of the reception side.

In addition, the present invention is applied to a contents providing method that make it possible to provide stream contents to a client terminal in response to a request from the client terminal and provide time information to which important information is assigned in the stream contents to the client terminal.

Thereby, according to the construction of the present invention, it is able to present a content providing method that is able to reflect the intention of the distribution side to the operation of the reception side.

In addition, the present invention is applied to a contents providing method for receiving stream contents transmitted from a predetermined server, and providing the stream contents to a user by carrying out a playback, watches the playback condition of a predetermined part of the stream contents specified by time information transmitted from the server, at least, and stops the playback of following stream contents based on the playback condition.

Thereby, according to the construction of the present invention, it is able to present a contents providing method that is able to reflect the intention of the distribution side to the operation of the reception side.

In addition, the present invention is applied to a playback program for stream contents for distributing the stream contents received from a predetermined server by carrying out a playback, watches the playback condition of the part of the stream contents specified by the time information notified from the server, at least, and makes the playback difficult for following stream contents based on the playback condition.

Thereby, according to the construction of the present invention, it is able to provide a playback program for stream contents that is able to reflect the intention of the distribution side to the operation of the reception side.

In addition, the present invention is applied to a recording medium on which a playback program for stream contents that are received from a predetermined server and provided by carrying out the playback of the stream contents, and this playback program for the stream contents watches the playback condition of a predetermined part of the stream contents specified by time information received from a server, makes a playback of following stream contents based on the playback condition difficult.

In addition, an embodiment consistent with the present invention is applied to a contents providing method for streaming content to a client terminal, comprising: dividing a media stream based on time increments into a plurality of content streams that are stored on a content server, the content streams representing consecutive portions of the media stream; receiving a request from a client for the media stream; transmitting a content stream table to the client, the content stream table identifying a network address and a time segment for each content stream; receiving a request from a client for a content stream; monitoring the rate of playback of the content stream during the time segment corresponding to the content stream; notifying the content server if the rate of playback during the time segment stays within a pre-determined playback rate; and responding, at the content server, to said notification by making a following content stream available for playback.

In addition, an embodiment consistent with the present invention is applied to a computer readable medium having program code stored thereon for streaming content to a client terminal, the program code being executable by a processor to perform operations comprising: dividing a media stream based on time increments into a plurality of content streams that are stored on a content server, the content streams representing consecutive portions of the media stream; receiving a request from a client for the media stream; transmitting a content stream table to the client, the content stream table identifying a network address and a time segment for each content stream; receiving a request from a client for a content stream; monitoring the rate of playback of the content stream during the time segment corresponding to the content stream; notifying the content server if the rate of playback during the time segment stays within a pre-determined playback rate; and responding, at the content server, to said notification by making a following content stream available for playback.

In addition, an embodiment consistent with the present invention is applied to an apparatus for streaming content to a client terminal, the apparatus comprising: means for dividing a media stream based on time increments into a plurality of content streams that are stored on a content server, the content streams representing consecutive portions of the media stream; means for receiving a request from a client for the media stream; means for transmitting a content stream table to the client, the content stream table identifying a network address and a time segment for each content stream; means for receiving a request from a client for a content stream; monitoring the rate of playback of the content stream during the time segment corresponding to the content stream; means for notifying the content server if the rate of playback during the time segment stays within a pre-determined playback rate; and means for responding, at the content server, to said notification by making a following content stream available for playback.

As described above, according to the construction of the present invention, it is able to present a recording medium on which a playback program for the stream contents is recorded that is capable of reflecting the intention of the distribution side to the operation of the reception side.

### BRIEF DESCRIPTION OF THE DRAWINGS

FIG. 1 is a block diagram showing a conventional distribution system;

FIG. 2 is a flow chart offered in explanation of the operation of the distribution system in FIG. 1;

FIG. 3, consisting of FIGS. 3A and 3B, is a time chart showing a case where one stream content is distributed by the plural stream contents;

FIG. 4 is a chart showing an URL table of the stream contents of FIG. 3;

FIG. 5 is a flow chart offered in explanation of the operation of the distribution system for the stream contents in FIG. 3;

FIG. 6 is a time chart corresponding to the operation of FIG. 5;

FIG. 7 is a flow chart offered in explanation of the operation when one content comprising the plural stream contents is carried out by a buffering distribution;

FIG. 8 is a time chart corresponding to the operation of FIG. 7;

FIG. 9 is a block diagram showing the distribution system related to the first embodiment of the present invention;

FIG. 10 is a time chart showing the stream contents distributed by the distribution system of FIG. 9;

FIG. 11 is a chart showing an URL table of the stream contents of FIG. 10;

FIG. 12 is a flow chart offered in explanation of the operation of the distribution system in FIG. 9; and

FIG. 13 is a flow chart offered in explanation of the operation of the distribution system related to the second embodiment of the present invention.

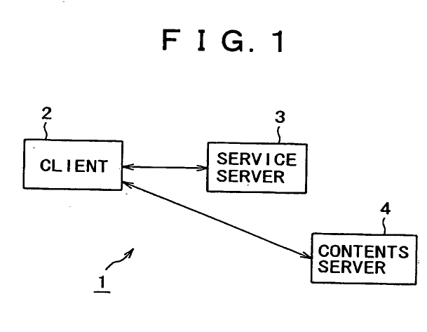

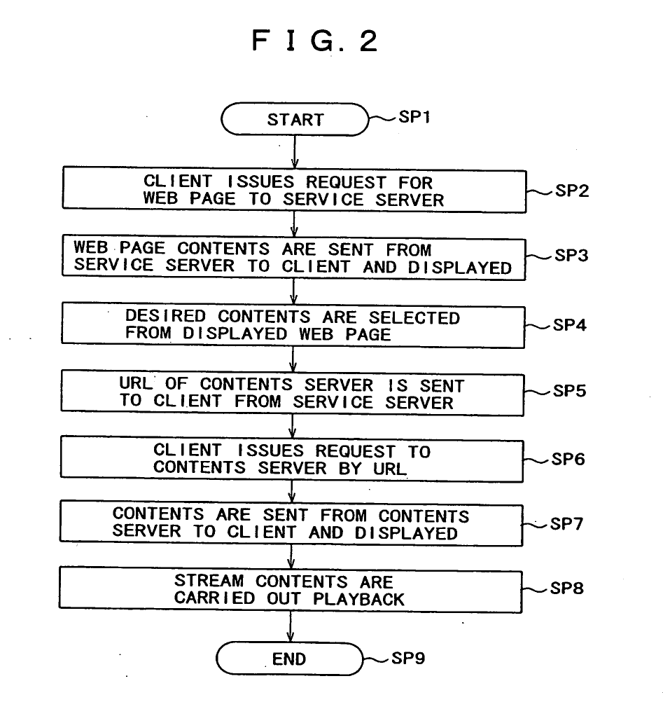

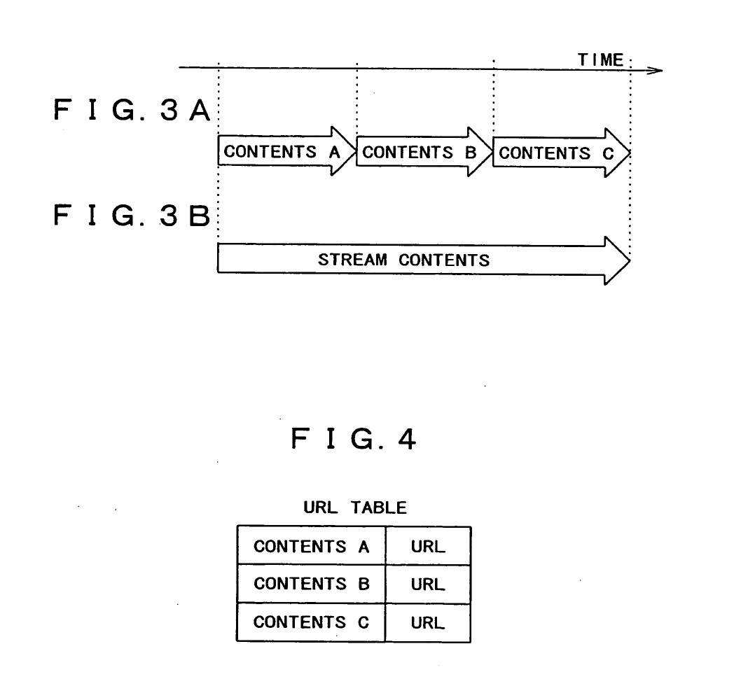

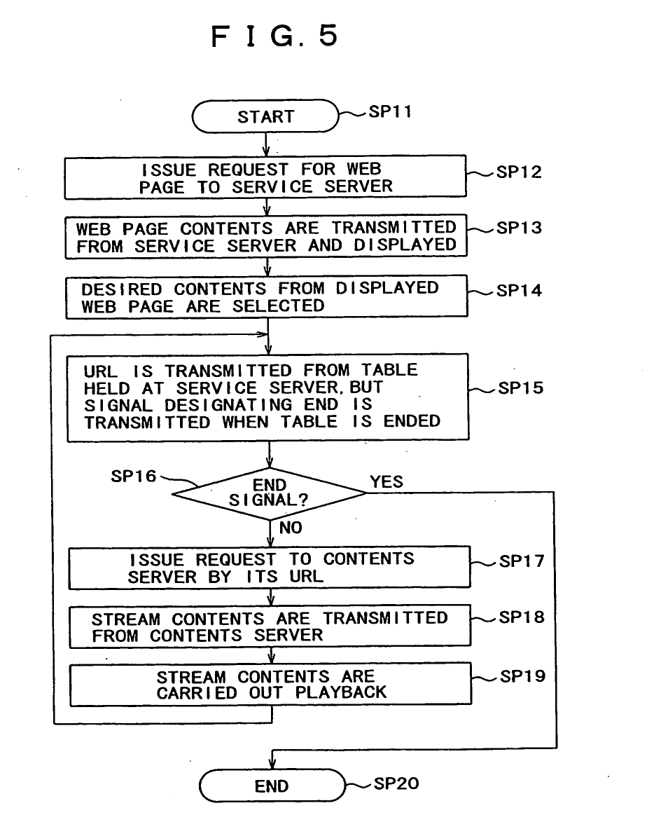

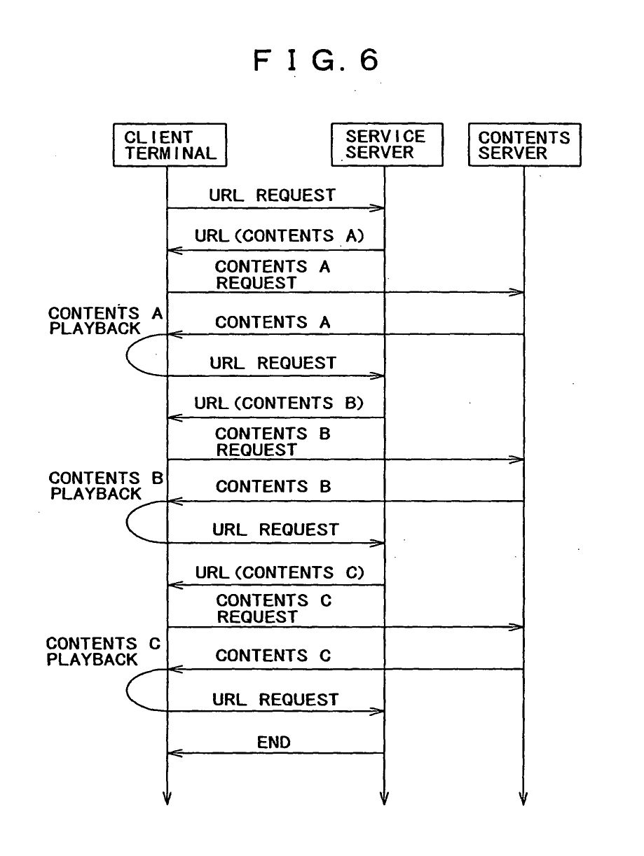

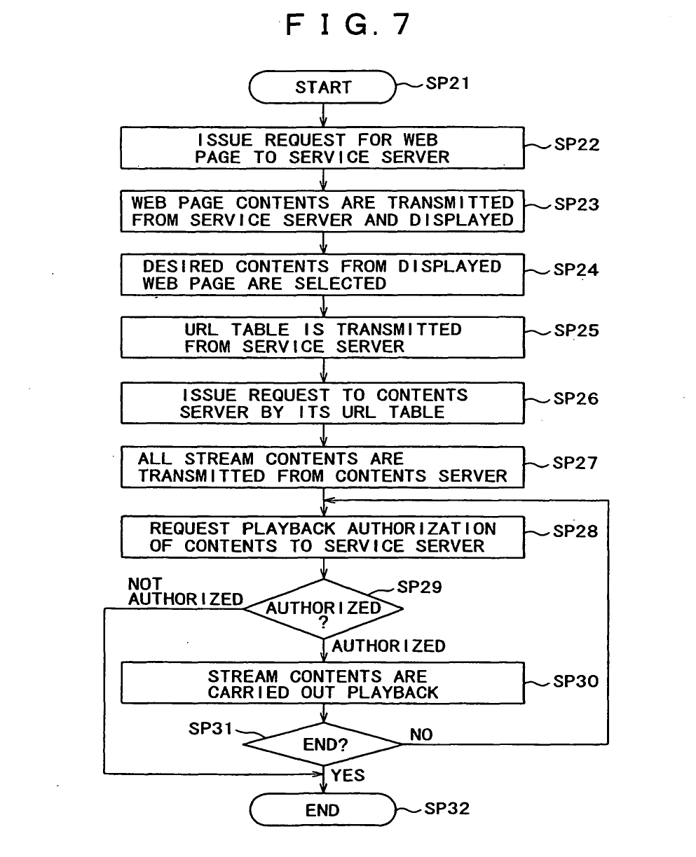

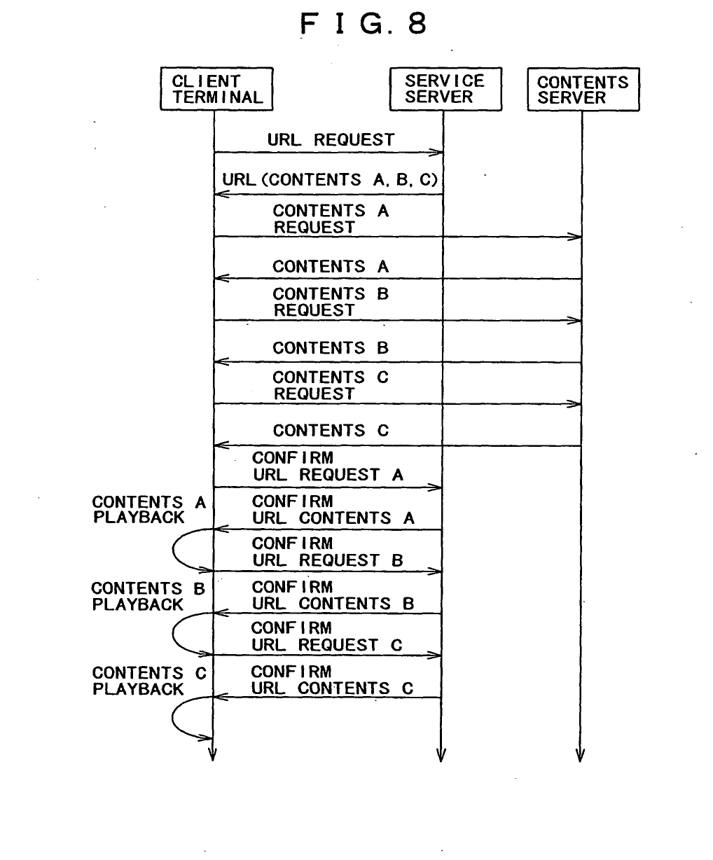

### BEST MODE FOR CARRYING OUT THE INVENTION

An embodiment of the present invention is explained in detail with reference to the accompanying drawings appropriately here-in-after.

(1) First Embodiment:

(1-1) Construction of the First Embodiment:

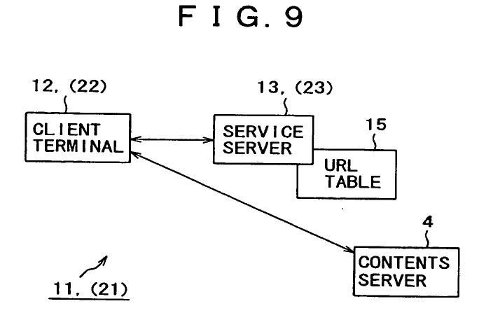

FIG. 9 is a block diagram showing a distribution system related to an embodiment of the present invention. In this distribution system 11, stream contents are distributed by a stream distribution.

In this distribution system 11, a service server 13 provides web page contents by accessing then from a client terminal 12, further accesses an URL table by accessing it by the web page contents, and provides the URL of a contents server 4. Thereby, the service server 13 is so arranged to notify the URL that user-desired stream contents are available for acquisition.

When notifying the URL, the service server 13 also notifies the client terminal 12 of the time information indicating start position and end position of a part to which important information is assigned. Here, this time information is set to every stream content with reference to the time code that is the time information of the stream contents.

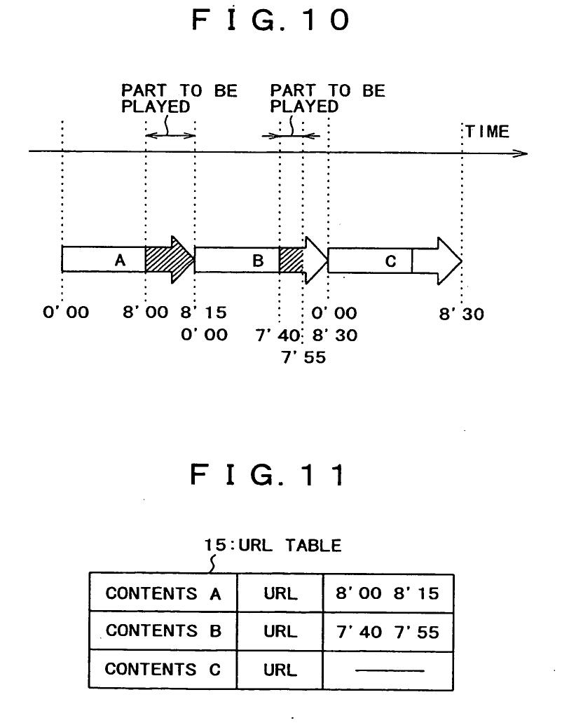

Namely, as shown in FIG. 10, in the case where one content is distributed as a sequences of three stream contents A, B, and C, the URL table 15 is, as shown in FIG. 11, constructed by recording URLs of every stream content A, B, and C. In addition, when, among these stream contents A, B, C, the important information is assigned to a range from 8 minutes 00 seconds to 8 minutes 15 seconds of the first stream content A and a range from 7 minutes 40 seconds to 7 minutes 55 seconds of the second stream content B, the URL table 15 is set to record the start time and the end time for these ranges corresponding to the stream content B and the stream content C, respectively.

As described above, in this embodiment, the service server 13 provides an address to be accessed regarding respective stream content constructing user-desired contents depending on the access from the client terminal 12, and further, it is set to provide recording positions of the important information assigned to each stream content with the time information of the stream contents. In this case, in the embodiment, such important information is a commercial.

Corresponding to this, the client terminal 12 acquires the web page contents by accessing the service server 13 with a predetermined browser software, and further it acquires the URL and the time information by accessing the service server 13 with this web page contents. Further, it downloads the stream contents by accessing the contents server 4 with the URL and carries out the playback of this stream contents by the playback application, which is a plug-in software of this browser software.

In this processing, the client terminal 12 watches the playback condition of the stream contents with the playback application based on the time information acquired from the service server 13, provides notification of the completion of correct processing based on the playback application only in the case when the playback processing by the standard speed is executed regarding the important information specified by this time information, and thereby authorizes accessing of the server for acquiring the URL of the stream contents, which follows after this.

Thereby, in this distribution system 11, when the processing such as fast-forward, skip, and the like is executed regarding the specified part set by the distribution side, it is set not to carry out the downloading of the following stream contents, and only in the case when this specified part carries out the correct playback, it is set to be able to carry out the downloading of the following stream contents, and thereby, it is set to keep everyone informed about the important information set at the distribution side by reflecting the intention of the distribution side to the operation of the reception side.

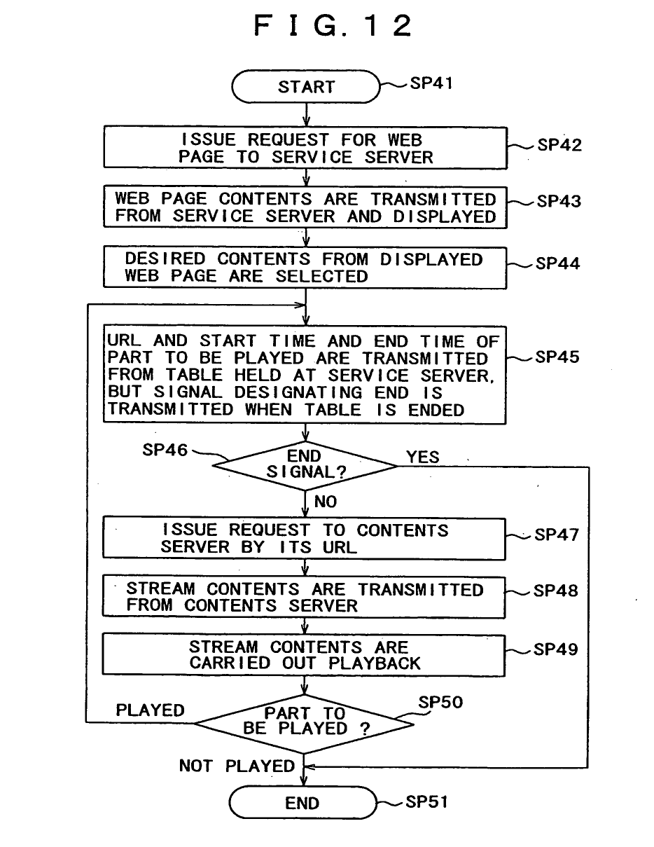

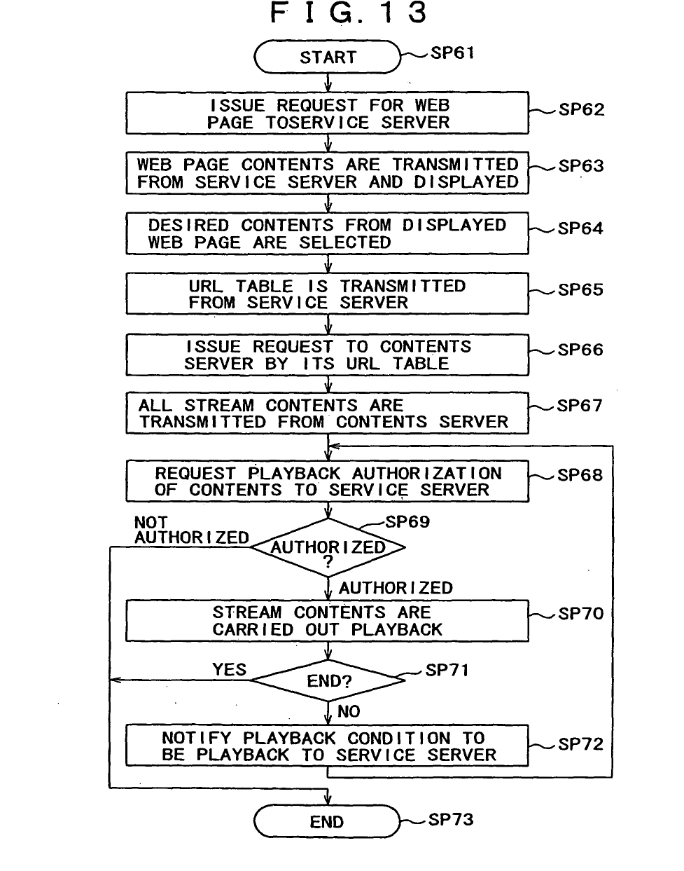

Namely, FIG. 12 is a flow chart showing a processing procedure of the stream contents in this client terminal 12. By the execution of the web browser, and further by the execution of the playback application which is downloaded and activated, the client terminal 12 executes this processing procedure.

In other words, in this the distribution system 11, the processing proceeds from a step SP41 to a step SP42 by accessing the service server 13 from the client terminal 12, and a request of the web page from the client terminal 12 is accepted by the service server 13. By this request, in a following step SP43, the service server 13 issues the web page contents introducing the contents available for provision, and the client terminal 12 displays the web page contents with the browser.

Further, in this the distribution system 11, in a step SP44, the user desired contents are selected by the selection of the user for this web page contents, and in a continuing step SP45, the corresponding URL of the contents server 4 is notified from the service server 13 by the access from the client terminal 12 based on the selection by the user. In this case, the service server 13 also provides the time information to which the important information is recorded from the record of the URL table. Further by repeating the access, it sequentially provides URL and time information of the continuing stream contents, and an end signal indicating the end is issued to the access after notifying the URL of the last contents and the time information.

In a following step SP46, the client terminal 12 determines whether the end signal from the service server 13 is obtained or not, and when a negative result is provided here, the processing proceeds to a step SP47. Here, the client terminal 12 requests the transmission of the stream contents by accessing the contents server 4 with the URL notified from the service server 13 and receives the stream contents transmitted from the contents server 4 in a step SP48 which is followed after this request. In addition, in a continuing step SP49, it carries out the playback of thus received stream contents, and when the playback is completed up to the end of the stream contents, the processing proceeds to a step SP50.

In this step SP50, the client terminal 12 determines whether the time information is simultaneously acquired with the URL or not. Further, in the case when the time information is acquired, it determines whether the part specified by the time information has carried out the playback with a standard playback speed or not. In this case, when this important part has carried out the playback with the standard playback speed, the client terminal 12 returns to the step SP45, and acquires a URL and time information of following stream contents, but when it does not carry out the playback of this important part with the standard playback speed, namely it does carry out the playback of this important part with fast-forward or skip, then the processing proceeds from the step SP50 to a step SP51, and the processing procedure ends.

In addition, similarly, the playback of the all stream contents is completed and the end signal is obtained from the service server 13, then the processing proceeds from the step SP46 to the step SP51 because a negative result is provided in the step SP46, and this processing procedure ends.

Thereby, the client terminal 12 is set to carry out the playback by acquiring following stream contents only in the case when the part specified by the distribution side has carried out the playback in accordance with the intention of the distribution side, but if the processing intended by the distribution side is not executed, then the acquisition of a following stream content is stopped and the processing is set to end.

(1-2) Operation of the First Embodiment

In the above-mentioned construction, in this distribution system 11 (FIG. 9), a list of the contents available for provision is distributed by the access of the service server 13 from the client terminal 12, and the URL of the corresponding stream content is obtained by accessing the service server 13 by the selection of the user in this list. Further, by the access of the contents server 4 with this URL, the corresponding stream content is downloaded to the client terminal 12, and thereby it is able to provide the user-desired contents by way of the client terminal 12.

In this the distribution system 11, a plurality of stream contents are formed by dividing one content time-sequentially (FIG. 10), and these stream contents are respectively provided by the stream distribution. Further, in the client terminal 12, when the playback of the one stream contents is completed by being provided to the user while receiving these stream contents and decoding, the URL of a following content is obtained by accessing the service server 13, and by repeating this processing, it provides continuous plural stream contents to the user and one stream contents of these plural stream contents is provided to the user.

In the distribution system 11, for carrying out the download of the stream contents from the contents server 4 and playback by sequentially acquiring URLs, when the URL is acquired, the start position and the end position of the important information set to the corresponding stream contents are provided with the time code which is the time information of the stream contents. Further, only in the case when the important information has carried out the playback as standard as intended by the distribution side, namely only in the case when the part to which the important information is assigned has carried out the playback with the normal playback speed by this time information, the URL for the following stream content is acquired by accessing the service server 13.

Thereby, the distribution system 11 is able to carry out the playback of following stream contents only in a case when the operation is done in the reception side as intended in the distribution side, and it is able to reflect the intention of the distribution side to the operation of the reception side.

(1-3) Effect of the First Embodiment

According to the above described construction, the time information is provided together with the URL of the stream contents, and the playback processing is watched, and only in the case where the operation in the reception side is done as intended by the distribution side the embodiment is able to reflect the intention of the distribution side to the operation of the reception side by making it possible to carry out the playback of following stream contents.

In this case, the stream contents are arranged to be distributed by the stream distribution, and only in the case when the stream contents have carried out the playback as intended by the distribution side, the URL of the following stream content is notified, and only in the case when the operation in the reception side is surely done as intended by the distribution side the embodiment is able to make the playback of the following stream content possible.

In addition, this time information is set by the time code which is the time information of the stream contents, so that it is able to watch the playback condition with a simple processing.

(2) Second Embodiment

In this embodiment, a distribution system distributes stream contents by a buffering distribution. In addition, the distribution system 21 related to this embodiment is the same as the distribution system 11 related to the first embodiment except that constructions of the service server and the client terminal are different, so that these constructions are explained by diverting FIG. 9.

In other words, in this embodiment, the service server 23 provides a list of the stream contents that are available for provision by access from the client terminal 22, and, in addition, by access from the client terminal 22 based on this list, the URL table 15 for the corresponding stream contents is provided to the client terminal 22. Further, by request from the client terminal 22, the playback condition is received as required, then, it authorizes the playback for each of the stream contents.

Corresponding to this, the client terminal 22 accesses the service server 23, receives a list of the stream contents available for provision, and further acquires the URL table 15 by accessing the service server 23 in accordance with this list with an operation by a user. Further after downloading all of the plural stream contents constructing one content by accessing the contents server 4 in accordance with the URL table 15, it sequentially carries out the playback of each of the stream contents. In the case of this playback, the client terminal 22 accesses the service server 23, notifies the playback condition of just before as necessary, and as the result, when a authorization for the playback is acquired from the service server 23, then carries out the playback of a following stream content. In other words, in this distribution system 21, as shown in FIG. 13, by the access of the service server 23 from the client terminal 22, the processing proceeds from a step SP61 to a step SP62, and a request of a web page from the client terminal 22 is accepted by the service server 23. By this request, in a continuing step SP63, the service server 23 issues web page contents introducing the contents available for provision, and the client terminal 22 displays this web page contents by a browser.

Continuing in this distribution system 21, in a continuing step SP64, user-desired content is selected successively by the selection by a user in this web page content, and in a continuing step SP65, the corresponding URL table 15 is provided from the service server 23 by the access from the client terminal 22 based on this selection by the user.

Thereby, in this distribution system 21, in a continuing step SP66, the contents server 4 is sequentially accessed by the URL recorded on this URL table, and in a continuing step SP67, the stream contents recorded in the URL table 15 are sequentially downloaded to the client terminal 22, and carry out the buffering.

In this way, when the buffering of the stream contents is completed, the client terminal 22, in a continuing step SP68, requests an authorization of playback for the stream contents to the service server 23, and in a continuing step SP69, determines whether the authorization is acquired or not. When the authorization is acquired here, in this distribution system 21, a playback for a top of the stream contents among the stream contents being buffered by the client terminal 22 is started in a continuing step SP70.

When the playback of this stream contents is completed, the client terminal 22, in a following step SP71, determines whether the playback of all the stream contents is completed or not, and if a negative result is provided , then the processing proceeds to a step SP72. In this case, in the client terminal 22, after the playback condition of the part to which the important information recorded in the URL table 15 is assigned is provided to the service server 23 based on the playback history of the adjacent stream contents, then the processing returns to the step SP68.

In the distribution system 21, it is determined whether the part to which the important information is recorded has carried out the playback with a standard playback speed or not, namely, it is confirmed that this part is has not carried out the playback with a fast-forward or skip but carried out the playback with the standard playback speed, then the playback of a following stream content is authorized, but when the playback is not carried out with the standard playback speed, then the playback for the following stream content is not authorized.

Thereby, in this distribution system 21, only in the case when a user continues to carry out the playback of the commercial with the standard playback speed is the processing procedure of the steps SP68-SP69-SP70-SP71-SP72-SP68 repeated, and after the desired contents of the continuing stream contents are distributed, the processing proceeds to a step SP73 from the step SP71, and then the processing procedure ends. On the contrary, in the case where the commercial has carried out the playback with the fast-forward, the processing proceeds from the step SP69 to the step SP70, the processing procedure ends, and thereby the playback for the following stream contents is stopped.

According to the construction as shown in FIG. 13, the embodiment is able also to reflect the intention of the distribution side to the operation of the reception side in the buffering distribution.

(3) Other Embodiments

In the abovementioned first embodiment, in the stream distribution, the case is described where the playback of the following stream content is made difficult based on the determination of the client terminal side, but this invention is not limited to this, and the playback condition is provided to the service server, and the playback of the following stream content may be set to be difficult based on the determination of the service server.

Further in the above described second embodiment, in the buffering distribution, the case is described where the playback condition is provided to the service server, and the playback of the following stream content is set to be difficult based on the determination of the service server, but the present invention is not limited to this, and like the first embodiment, the playback of the following stream content may be set to be difficult based on the determination of the client terminal side.

Further, in the above described embodiment, the case is described where a part to which important information is assigned by the time information is notified, but the present invention is not limited to this, and the time information may be transferred by the setting of the flag in the stream contents and the like.

In addition, in the above-mentioned embodiment, the case is described where the URL table and the time information are transmitted from the service server, but the present invention is not limited to this, and the time information may be transmitted together with the stream contents, and further, only the time information may be transmitted separately.

As described above, according to the present invention, it provides the time information to a transmission target of the stream contents, watches a playback condition of a specified part at least by the time information, and only when the operation at a reception side is done as intended by a distribution side, the playback of the following stream content is authorized, and, accordingly, it is possible to reflect the intention of the distribution side to the operation of the reception side.

One or more embodiments of the present invention may relate to a content providing apparatus, a content providing method, a playback program for stream contents, and a recording medium on which a playback program for stream contents is recorded, and it is able to apply to the case where music and video are distributed through the Internet, for example.

1. A contents providing method for streaming content to a client terminal, comprising:
dividing a media stream based on time increments into a plurality of content streams that are stored on a content server, the content streams representing consecutive portions of the media stream;
receiving a request from a client for the media stream;
transmitting a content stream table to the client, the content stream table identifying a network address and a time segment for each content stream;
receiving a request from a client for a content stream;
monitoring the rate of playback of the content stream during the time segment corresponding to the content stream;
notifying the content server if the rate of playback during the time segment stays within a pre-determined playback rate; and
responding, at the content server, to said notification by making a following content stream available for playback.

2. A computer readable medium having program code stored thereon for streaming content to a client terminal, the program code being executable by a processor to perform operations comprising:
dividing a media stream based on time increments into a plurality of content streams that are stored on a content server, the content streams representing consecutive portions of the media stream;
receiving a request from a client for the media stream;
transmitting a content stream table to the client, the content stream table identifying a network address and a time segment for each content stream;
receiving a request from a client for a content stream;
monitoring the rate of playback of the content stream during the time segment corresponding to the content stream;
notifying the content server if the rate of playback during the time segment stays within a pre-determined playback rate; and
responding, at the content server, to said notification by making a following content stream available for playback.

3. An apparatus for streaming content to a client terminal, the apparatus comprising:
means for dividing a media stream based on time increments into a plurality of content streams that are stored on a content server, the content streams representing consecutive portions of the media stream;
means for receiving a request from a client for the media stream;
means for transmitting a content stream table to the client, the content stream table identifying a network address and a time segment for each content stream;
means for receiving a request from a client for a content stream;
monitoring the rate of playback of the content stream during the time segment corresponding to the content stream;
means for notifying the content server if the rate of playback during the time segment stays within a pre-determined playback rate; and
means for responding, at the content server, to said notification by making a following content stream available for playback.
